(19) United States
(12) Patent Application Publication
(10) Pub. No.: US 2005/0247819 A1
(43) Pub. Date: Nov. 10, 2005

(54) LIGHTWEIGHT VEHICLE OPERABLE ON LAND, WATER AND IN THE AIR

(76) Inventor: Anthony Caruso, Enfield, CT (US)

Correspondence Address: TED PAULDING, 10 PENWOOD LA., WETHERSFIELD, CT, 06109, US

(21) Appl. No.: 10/841,303

(22) Filed: May 8, 2004

(51) Int. Cl. B64D 5/00

(52) U.S. Cl. 244/2; 244/13; 244/902; 244/903

(57) ABSTRACT

A land, water and air vehicle comprising a kayak body, two power driven mountain bike wheels and two mounting bike steering wheels. A large propeller powers the vehicle on water and in the air and a parachute is employed for air travel. The parachute is adapted to fold for storage and a tent and air mattress can also be mounted on the body of the vehicle.

### BACKGROUND OF THE INVENTION

Various types of combined land, water and air craft have been designed and developed but little or no commercial success has been achieved with any of these vehicles. The vehicle of the present invention is extremely light weight, relatively simple in design and embodies a number of improvements which are believed to be conducive to commercial success.

### SUMMARY OF THE INVENTION

The vehicle of the invention has a body which is preferably in the form of a kayak with at least three wheels and preferably four, two of which are power driven and two of which are adapted for steering. A large propeller mounted on the body discharges air rearwardly for air and water propulsion . A parachute is also provided with its greater dimension perpendicular to the kayak centerline and with its front and rear edges curved downwardly Flexible retaining means connect the parachute to the body and at least one rear and one front elongated outrigger, preferably two in front, secure the parachute in position and prevent inadvertent collapse. A tent is also provided and is adapted to be mounted on the body of the vehicle for survival or simply for recreation.

### DRAWINGS

FIG. 1 is a top plan view of the land, water and air craft of the invention,

FIG. 2 is a side view of the craft,

FIG. 3 is a front view of the craft,

FIG. 4 is a bottom view showing the operation of the steering wheels,

FIG. 5 is a perspective view showing the craft with the parachute stowed and the tent erected,

FIG. 6 is a fragmentary view showing an outrigger and its ball-socket mount,

FIG. 7 is a further fragmentary view of an outrigger with its mount in an exploded condition

FIG. 7a is a fragmentary top view of an outrigger mount,

FIG. 8 is a fragmentary enlarged view of a single power driven wheel and its support structure,

FIG. 9 is a fragmentary enlarged view of a single steering wheel, and

FIG. 10 is a fragmentary enlarged side view of a single wheel, an associated pontoon and wheel fender.

### DESCRIPTION OF PREFERRED EMBODIMENT

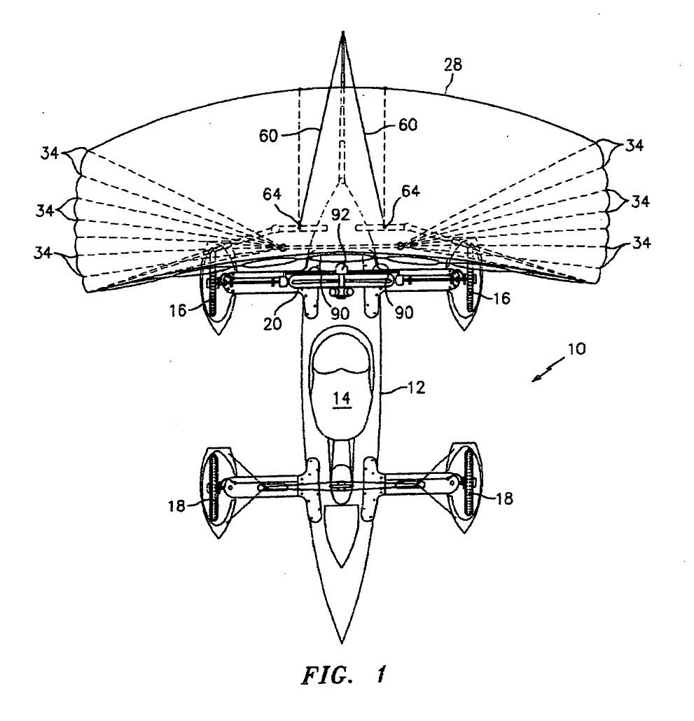

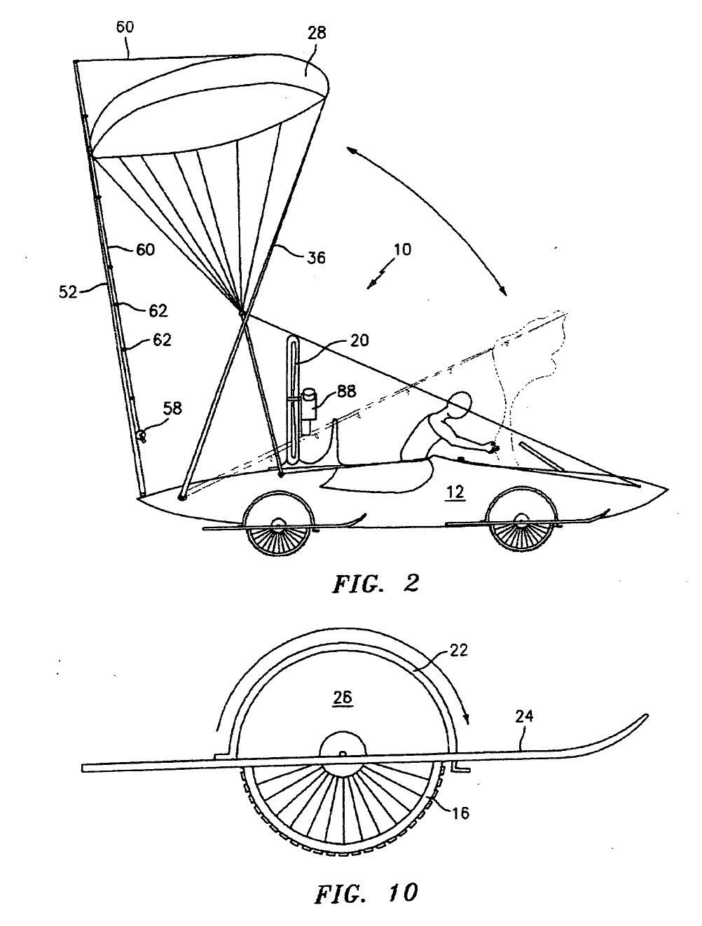

Referring particularly to FIGS. 1 and 2, a land, water and air vehicle indicated generally and has a body 12 in the form of a kayak having an operator's compartment 14. The kayak may be conventional but should be of the best quality available. At least three bicycle style wheels, preferably the best quality mountain bike wheels, are provided with four (4) shown, two (2) rear wheels 16,16 and two (2) front wheels 18,18. The rear wheels 16,16 are power driven as will be explained more fully herein below and the front wheels 18,18 are adapted to steer the vehicle on land and in the water. A large propeller 20 is mounted on the kayak behind the operator's compartment and is operable to discharge air rearwardly and generally longitudinally of the kayak for forward movement of the vehicle in the water. Preferably, the propeller is mounted for pivotal movement about a vertical axis for steering of the vehicle in air and water travel and, optionally, the front wheels may also serve a steering function in the water as well as on land.

Referring to FIG. 10, a single representative front wheel 16 shown has an associated fender 22 which can be swung from the upright position shown to a lowered position beneath a pontoon 24. In its lowered position, a side wall 26 of the fender provides resistance to the water with the vehicle in motion and cooperates with the propeller, or, in the alternative may serve as the sole steering means for the vehicle.

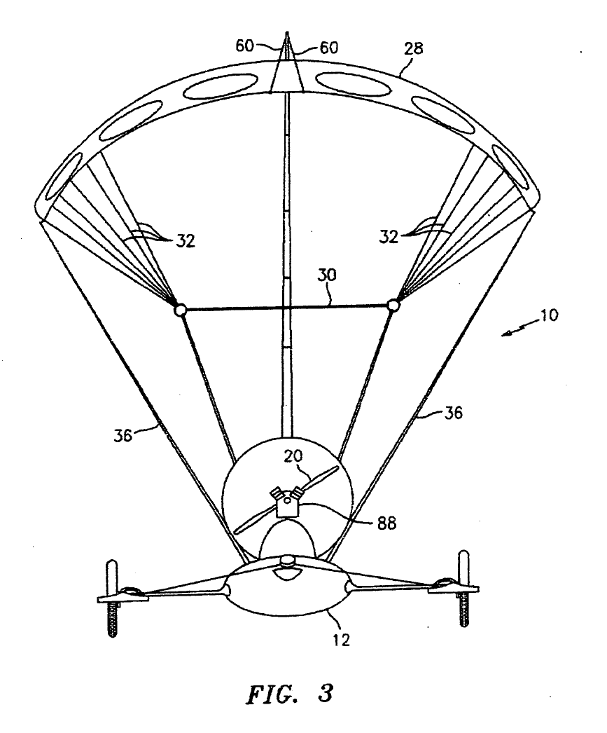

Referring now to FIGS. 1, 2 and 3, a parachute 28 takes a generally rectangular configuration with its longer dimension perpendicular to the centerline of the kayak and with front and rear edge portions curved downwardly. The parachute is or may be conventional. As best seen in FIG. 3, a flexible inverted “U” shaped member 30 is connected to the kayak at its open end and at its upper closed end a series of lines 32,32 extend from each corner upwardly to spaced connecting points 34,34 along opposite side edges of the parachute. At opposite front corners of the parachute upper end portions of a pair of outriggers 36,36 are connected to the parachute with each outrigger extending downwardly to the kayak. The outriggers may take the form of deep sea fishing poles.

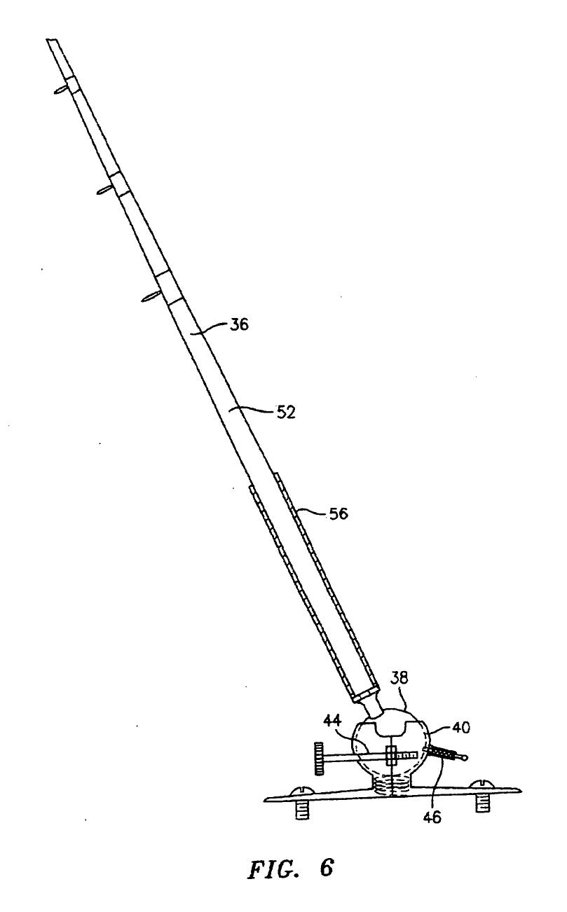

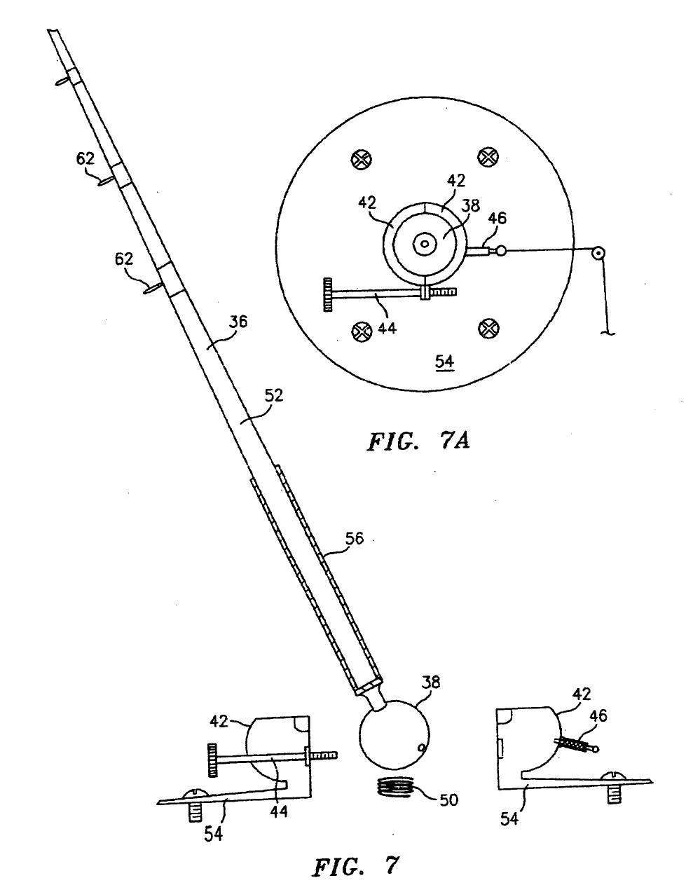

At its lower end portion each outrigger has a pivotal connection with the kayak as best illustrated in FIGS. 6, 7 and 7a. Preferably, a ball-socket type connection is employed with ball 38 provided at the lower end of each outrigger and a cooperating socket mounted on the kayak at 40. Each socket 40 is formed in two mating halves 42,42 which are held in assembled position by a small bolt 44. A lock pin 46 is also provided and is adapted for remote operation by a line 48. Spring 50 within the socket frictionally engages ball 51 for smooth controlled pivotal operation with the lock pin removed.

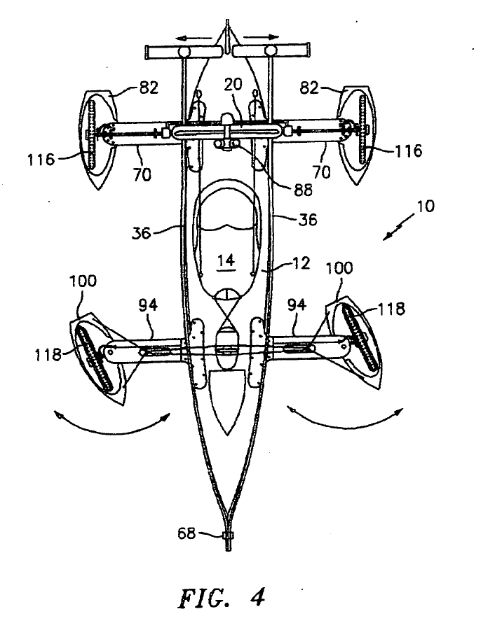

Reverting now to FIGS. 1, 2 and 3, it will be observed that a rear outrigger 52 is also provided and is mounted on a rearwardmost end portion of the kayak. The outrigger 52 has a ball-socket mount similar to that of the outriggers 36,36 with a socket 40 mounted on support plate 54 shown in FIGS. 6, 7 and 7a. The ball-socket assemblies for the outriggers 36,36 are adjustably mounted on a transverse support member as best illustrated in FIG. 4. It should also be noted in FIG. 7 that a lower end portion of outrigger 52 is telescopically received in a tubular member 56 connected with the ball 51. Thus, the outrigger 52 can be easily removed from the member 56 for storage.

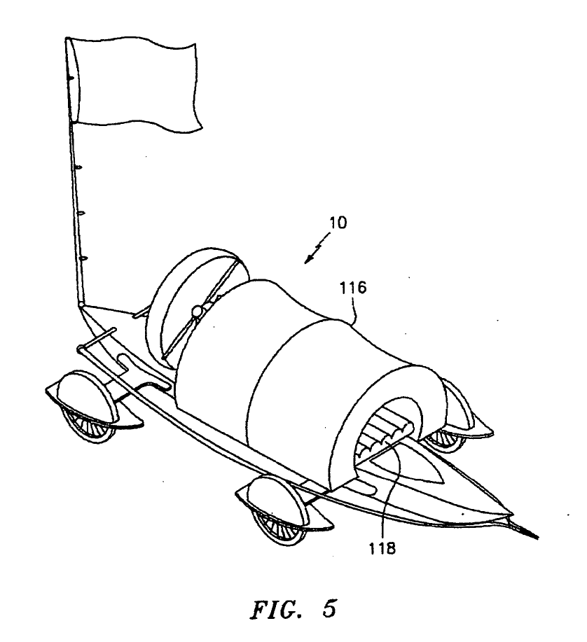

Returning again to FIGS. 1, 2 and 3, it will be observed that outrigger 52 may take the form of a deep sea fishing pole and may have a reel 58 mounted thereon with a pair of lines 60,60 running through guides 62,62 on the pole to its upper end. As best seen in FIG. 1, the lines 60,60 separate as they leave the uppermost guide 62 and extend forwardly to transversely spaced points of attachment 64,64 at a front portion of the parachute. As will be apparent, the outriggers 36,36 and 52 support the parachute in its operative position and the operator of the vehicle may manipulate the parachute as desired employing the “U” shaped member 30 and the connecting lines 32,32. When it is desired to store the parachute for use of the vehicle on land or water, the outriggers 36,36 may be swung forwardly as illustrated in FIG. 2 and the parachute stored in a compartment 66 best illustrated in FIG. 1. During the storage operation, the rear outrigger 52 may be removed from the member 56 and stored along one side or the other of the kayak. Outriggers 36,36 may be secured together in their storage positions at their top or forward end portions as in FIGS. 4 and 5 by a simple clip element 68.

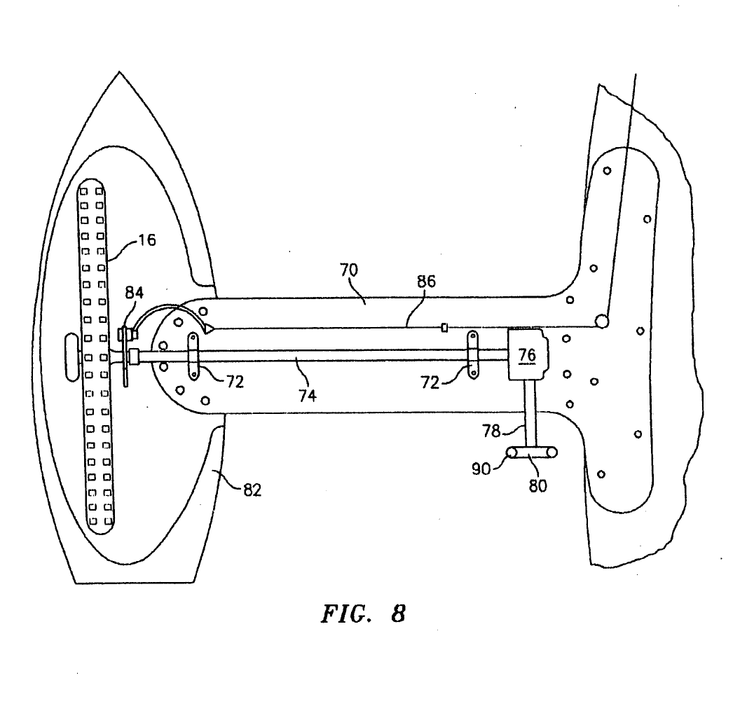

The enlarged wheel and wheel assembly shown in FIG. 8 is representative of both rear wheels 16,16. A supporting strut 70 which may be constructed from a surf board extends from the body of the vehicle and carries bearings 72,72 which journal a drive shaft 74 which in turn carries a wheel 16 at its outer end. At its inner end a small transmission 76 is provided and is in turn driven by a stub shaft 78 which carries a pulley 80 at its free end. Pontoon 82 is also carried by the strut 70 and has an opening therethrough receiving the wheel 16. Brake 84 is of the hydraulic disc type and is controlled by the vehicle operator via a cable 86.

Power for driving the vehicle on land is preferably provided by a small internal combustion engine 88 which also drives the propeller 20 and which is best illustrated in FIGS. 1 through 4. Drive belts 90,90 extend from a main pulley 92 at the rear of the propeller, a belt 90 being partially shown in FIG. 8. Alternatively, a separate small scooter type motor, not shown, may be provided to drive the rear wheels 16,16, or, a separate drive wheel, not shown, may be operated by the scooter motor and provided with a pivotal mount so as to be swung downwardly into engagement with the surface therebeneath.

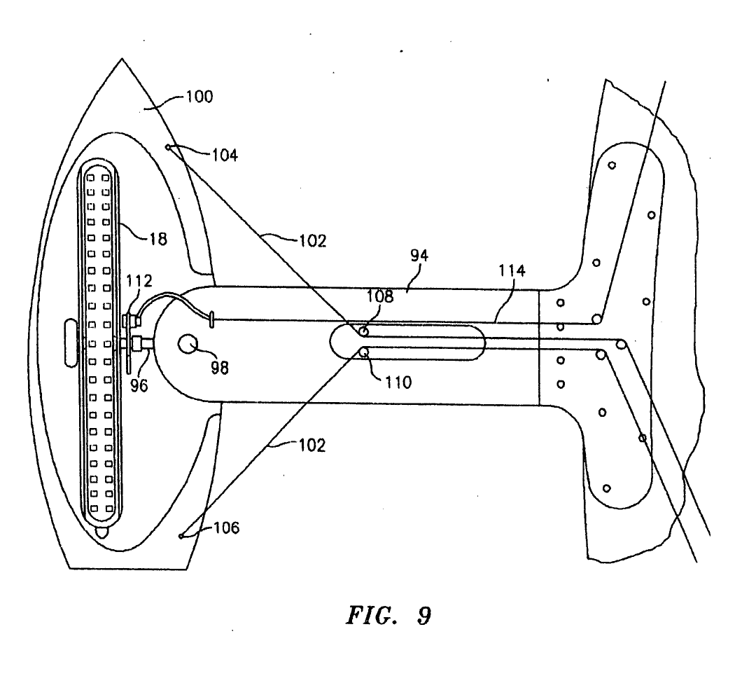

A front wheel assembly in FIG. 9 is representative of both wheels 18,18 and includes a strut 94 which may also be constructed from a surf board and which supports a stub shaft 96 which is pivotally mounted at its inner end at 98 and which carries a wheel 18 at its out end. Pontoon 100 is also pivotally mounted at 98 and controls the steering of the wheel 18 by means of a pair of cables 102,102 connected in spaced relationship to the pontoon at 104, 106. The cables 102, 102 extend to small pulleys 108, 110 and then to a joy stick or steering wheel, not shown, in the operator's compartment. A disc brake at 112 is also operated by cable, partially shown at 114, and which extends to the operator's compartment.

Finally, a tent and air mattress may be provided for mounting on the body of the vehicle as at 116 and 118.

As will now be apparent, a land, water and air vehicle of extremely simple and yet highly efficient design and construction has been provided. The vehicle is also of exceptionally light weight in the neighborhood of 3 to 400 pounds including the operator.

1. A lightweight vehicle operable on land, water and in the air; said vehicle comprising a body in the form of a kayak having an operator's compartment, at least three bicycle style wheels with at least one wheel mounted for rotation at one end of the body and at least two wheels mounted for rotation at an opposite end of the body, at least one of said wheels adapted for connection with power operating means and at least one of said wheel adapted for rotation about a vertical axis for steering the vehicle on land, steering mechanism operable by the vehicle operator connected with said steering wheel, power operating means connected with said wheel adapted for connection with the same, a large propeller mounted for front to rear air moving operation generally parallel with the longitudinal centerline of the kayak, small pontoon means associated with each wheel, generally rectangular parachute with its larger dimension perpendicular to the kayak centerline and with front and rear edge portions curved downwardly, flexible retaining means connecting the parachute to the kayak body, and rigid support means for the parachute comprising at least one rear outrigger and at least one front outrigger, each outrigger comprising a narrow elongated member connected at one end to the kayak and an opposite end to the parachute.

2. A lightweight vehicle as set forth in claim 1 wherein two [2] front outriggers are provide with upper end portions connected respectively with opposite front end portions of the parachute.

3. A lightweight vehicle as set forth in claim 2 wherein each of the three outriggers has a ball and socket connection with the kayak.

4. A lightweight vehicle as set forth in claim 2 wherein the rear outrigger has a forwardly extending bifurcated connector at its upper end which attaches to the parachute intermediate its front and rear edges.

5. A lightweight vehicle as set forth in claim 2 wherein the flexible retaining means takes the form of a lightweight generally inverted U-shaped flexible frame and a plurality of flexible elements extending therefrom to spaced connecting points along opposite side edges of the parachute.

6. A lightweight vehicle as set forth in claim 1 wherein four [4] wheels are provided with two mounted at the front of the kayak and two mounted at the rear, the rear wheels being connected with the power operating means and the front wheels each being rotatable about vertical axes and connected with the operator's steering system.

7. A lightweight vehicle as set forth in claim 1 wherein each wheel has a small pontoon associated therewith, the wheels being located in slots in the pontoons and projecting therebeneath.

8. A lightweight vehicle as set forth in claim 7 wherein each wheel has an associated fender, and wherein the fenders are adapted to rotate downwardly through the pontoon slots to protect the wheels in water and to enhance the steering of the vehicle in the water

9. A lightweight vehicle as set forth in claim 1 wherein the propeller is mounted for rotation about a vertical axis for steering the vehicle in water and in the air.

10. A lightweight vehicle as set forth in claim 1 wherein a tent is provided and is configure so as to rest on the top of the kayak.

11. A lightweight vehicle as set forth in claim 10 wherein an air mattress is provided and carried by the kayak.
